(19) United States
(12) Patent Application Publication
(10) Pub. No.: US 2013/0073318 A1
(43) Pub. Date: Mar. 21, 2013

(54) SYSTEM AND METHOD FOR PROCESSING DATA FOR INSURANCE ISSUED TO INDIVIDUALS AND PROVIDING FOR COVERAGE OF RELATED INDIVIDUALS

(71) Applicants: Julia M. Feldman, West Hartford, CT (US); Sandra Egan Belcourt, Hamden, CT (US); Daniel D. Blau, Farmington, CT (US); Jodi L. Olshevski, West Hartford, CT (US)

(72) Inventors: Julia M. Feldman, West Hartford, CT (US); Sandra Egan Belcourt, Hamden, CT (US); Daniel D. Blau, Farmington, CT (US); Jodi L. Olshevski, West Hartford, CT (US)

(73) Assignee: HARTFORD FIRE INSURANCE COMPANY, Hartford, CT (US)

(21) Appl. No.: 13/233,470

(22) Filed: Sep. 15, 2011

(51) Int. Cl. G06Q 40/00

(52) U.S. Cl. 705/4

(57) ABSTRACT

A computer system is configured to process data related to a multi-generational insurance policy issued to a policy holder and providing coverage for one or more policy members having a family relationship with the policy holder. The system has a data storage device storing data associated with the policy, including coverages of the policy holder, coverages for each of the policy members, and a family relationship between the policy holder and the policy members. The system is configured to process insurance transactions initiated from a user-accessible device and related to the multi-generational policy.

### FIELD OF INVENTION

The present invention relates to computer systems, and particularly to computer systems for use in the financial services field, and particularly for processing of data related to insurance policies.

### BACKGROUND

Insurance policies, such as property and casualty policies for risks associated with ownership and operation of automobiles, and homeowner policies, are typically issued to an insured, and cover the insured's automobiles and home. If an insured has children living at home who are licensed drivers, and who drive the automobiles of the insured, the children may be covered as insureds under an automotive policy issued to the insured. A child, upon moving to a different residence and acquiring ownership of the child's own car, must generally arrange for his or her own insurance policies for automotive risks, as well as homeowners policies or other protection of property, such as renters' insurance.

Young adults may live with their parents, drive cars which are titled to their parents, and be covered under their parents insurance policies for automotive insurance. The young adults move away from the parental residence to a different residence, such as when upon obtaining a first job, and acquire title to their own cars. Upon moving to their own residence and acquiring his or her own car, a young adult generally needs to obtain separate automotive insurance, on a policy separate from a policy issued to the parents. It is common for young adults to maintain a residence separate from that of their parents for some period of time, and then reside with their parents again. For example, a young adult may have their own residence after obtaining a first job or after marrying. The young adult may subsequently move back and reside with his parents again as a transition as a result of other life changes, such as after becoming unemployed, during further education, or as a result of divorce, separation or other life events. Young adults who live with their parents and own their own vehicles are not generally able to obtain vehicle coverage on their parents' policies.

Young adults may have limited income and limited experience in managing money and other financial matters. As a result, parents may continue to be involved in their children's financial affairs. For example, parents may provide direct financial assistance to children. Parents may take other roles, such as paying bills for specific expenses, such as insurance premiums. Parents may also wish to review the financial and other affairs of their adult children, such as to verify that adult children have obtained necessary insurance coverage and paid insurance premiums in a timely manner. Young adult children, on the other hand, may prefer independence from their parents, even if the young adult children are not necessarily financially or temperamentally ready for complete independence. Young adult children may accordingly resent inquiries from parents as to such financial steps as maintaining appropriate insurance coverage and timely payment of premiums, resulting in conflicts within families.

In addition to young adults, other individuals may be observed as needing assistance with handling insurance and other financial affairs. For example, middle aged adults may observe that older parents and other older relatives require financial assistance, due to reduced income, or have difficulty continuing to manage financial affairs. In an older couple, one member of the couple may have been handling financial matters for many years. Upon the death or serious illness of one of the couple, the healthy or surviving member may be unfamiliar with financial matters. Once children observe the lack of familiarity with financial matters, the children may provide financial assistance or management of financial affairs. This may be done on an informal basis, without the children obtaining rights of guardianship or exercising powers of attorney. However, older adults may also not feel that they require the financial assistance or other involvement of adult children. Accordingly, difficult conflicts may arise between older adults and their adult children or other adult relatives around the financial matters of the older adults.

Involvement of adults in the financial arrangements of their young adult children and older parents is often desirable and in fact takes place. However, by way of example, a typical personal automotive insurance policy does not reflect the possible involvement of parents of adult children. An insurance company issues a personal automotive policy to an individual who is the sole owner of a vehicle, and does not provide an option for someone other than the insured to choose to receive communications concerning the policy. While in some cases the insured may be able to choose to have someone else receive communications, another family member is not able to advise the insurance company that the other family member should receive, for example, cancellation notices or other notices pertinent to the policy.

By way of further example, parents cannot choose to receive notifications related to a homeowner's insurance policy or a renter's insurance policy of a young adult child, unless the parents have an insurable interest in the insured property. In some instances, a homeowner may have a separate apartment with a separate address within their home. For example, the homeowner may rent the apartment at times to unrelated persons to obtain rental income. A young adult child or an older relative may take up residence in such an apartment as a result of various life changes, such as divorce or loss of employment of a young adult child, or, in the case of an older relative, death of a spouse or simply downsizing from a larger home. A renters insurance policy covering the possessions for such an apartment may typically be issued to the young adult child or older relative residing in the apartment, with no provision for notification or payment by the owner of the residence.

The restriction on communication to the insured may be in conflict with the flexibility that families exhibit in involvement in their respective financial affairs. Adult parents are often involved in insurance payments, discussion of policy terms and coverage, and other types of assistance and advice for adult children. Similarly, the children of older parents often become involved in insurance and other financial matters.

It would be desirable to provide a mechanism that provides for, by way of example, permitting an adult to be able to arrange for insurance coverage for other adult family members, such as adult children and parents. It would further be desirable for the adult to be able to verify continuing coverage, confirm that required premium payments have been made and other necessary actions have been taken, and make premium payments. Such a mechanism would desirably provide for considerable flexibility that can reflect the variety of arrangements that families may develop in involving adults in the financial affairs of their adult relatives.

### SUMMARY

In an embodiment, a computer system for processing data related to a multigenerational insurance policy issued to a policy holder by an issuer, includes: a data storage device storing data associated with the policy, the data associated with the policy including data related to the policy holder; one or more coverages for the policy holder, one or more benefits associated with the policy holder one or more coverages for one or more policy members, a family relationship between the policy holder and each of the policy members and an association of the one or more benefits with each of the policy members; an interface device for communicating with a user accessible device and the data storage device; and a processor in communication with the data storage device and the user accessible device, the processor configured to: cause the user accessible device to display policy data, including policy holder data and policy member data; receive via the user accessible device data indicative of a user-initiated policy transaction; responsive to receipt of the data indicative of the user-initiated policy transaction, cause the user accessible device to display data indicative of the policy transaction, and provide an output signal to an insurance computer system having data indicative of the user-initiated policy transaction.

In an embodiment, a computer-implemented method for processing data related to a multigenerational insurance policy issued to a policy holder and providing coverage to the policy holder and one or more policy members, includes: receiving at a processor of a computer system configured to process data related to multi-generational insurance policies, from a user-accessible device, data indicative of a request to initiate a policy transaction; responsive to the request, accessing by the processor from a data storage device in communication with the processor data related to the policy, the data stored in the data storage device including data related to the policy holder, one or more coverages of the policy holder, the one or more policy members, one or more coverages of the one or more members, and a family relationship between the policy holder and each of the members; causing by the processor the user accessible device to display data responsive to the request for the policy transaction, and providing by the processor an output signal to an insurance computer system having data indicative of the user-initiated policy transaction.

In an embodiment, a non-transitory computer-readable medium, the computer-readable medium having processor-executable instructions stored thereon, which instructions, when executed by the processor, cause the processor to: receive from a user-accessible device data indicative of a request to initiate a policy transaction related to a multi-generational insurance policy issued to a policy holder and having coverage for at least one policy member, selected by the policy holder and having a family relationship with the policy holder; responsive to the request, access from a data storage device data related to the policy, the data stored in the data storage device including data related to the policy holder, coverages related to the policy holder; coverages of the at least one policy member; and a family relationship between the policy holder and the at least one policy member; and provide an output signal for causing the user accessible device to display data responsive to the request for the policy transaction.

### BRIEF DESCRIPTION OF DRAWINGS

FIG. 1 is a schematic diagram showing an environment in which a system according to the embodiment may be used.

FIG. 2 is a schematic diagram of an exemplary computer system for implementation of a method and system of the invention.

FIG. 3 is a schematic diagram of an exemplary computer hardware server with networked devices for implementation of a method and system of the invention.

FIG. 4 is a schematic diagram of an exemplary computer server and process flow diagram for implementation of a method and system of the invention.

FIG. 5 is an exemplary screen shot of a screen on a client device in communication with a system for administration of insurance policy related data in accordance with an embodiment.

FIG. 6 is an exemplary screen shot of a screen on a client device for facilitating user selection and updating of policy members in an embodiment.

FIG. 7 is an exemplary screen shot of a screen on a client device for facilitating client addition of a new policy member.

FIG. 8 is an exemplary screen shot showing premium billing data generated by a system in accordance with an embodiment, showing premiums allocated to policy members.

FIG. 9 is a schematic diagram illustrating data related rights of various individuals in relation to a multi-generational insurance policy in an embodiment.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for processing of data relating to insurance policies and premiums. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

Insurance company customers desire flexibility in insurance arrangements that reflect the wide variety of flexibility in responsibility in family relationships. Responsibility for payment of premiums, arrangement for coverage, and verification of coverage may be distributed in various manners among related adults.

In an embodiment, the need for flexibility is addressed by an insurance company data processing system and method for processing data for an insurance policy that is issued to a primary policyholder, and that provides coverage for policy members related to the primary policyholder. The primary policyholder may access the insurance company data processing system to implement choices such as selection of policy members, selection of available coverage, payment of premiums for coverage of members, receipt of notifications relating to coverage of members, verification of status of coverage of policy members, and other data. The system may be configured to permit members to be selected by the primary policyholder and to issue and administer data relating to coverage for members who are adults who do not reside at the same address as the policyholder. The system may be configured to permit a primary policyholder to designate coverage for members relating to property in which the primary policyholder does not have an insurable interest. In an embodiment, the policy may be termed a “multi-generational insurance policy,” as policy members may include adult children and parents of a policyholder. However, in embodiments, the insurance company system may be configured to permit a policyholder to access the system and to select coverage for policy members who are in the same generation as the policyholder, such as siblings. The system may be configured to continue coverage for members if the members change addresses, including moving to the same address as the primary policyholder. The system may be configured to, responsive to policyholder designation of a new member, to deny coverage for the new member only under limited conditions, such as receipt of data indicative of unusually high risk events relating to the new member, such as vehicular homicide, one or more convictions for driving while intoxicated, insurance fraud or other relevant data. The system may be configured to provide that benefits associated with the primary policy holder in an accessible database be associated with the members. By way of example, system data may include data associating a primary policy holder with a reduction in deductible, a premium credit, an increase in maximum coverage, or other benefit, based on algorithms using data indicative of reasons as number of renewals, period of time since most recent claim paid by insurance company, or other reasons. Upon addition of a new member to the policy, the system may be configured to access data indicative of such benefits associated with the policyholder, and to associate such benefits and conditions with the new members.

The policy may be a property and casualty policy, such as an automotive or homeowners or renters policy. The coverage may be available for automobiles owned by either the primary policyholder or the members, regardless of whether the primary policyholder has an insurable interest, such as a partial ownership or a lien, in the automobile. For a homeowners or renters policy, the coverage may be available for a member with respect to property owned by the member, even if the primary policyholder does not have an insurable interest in the property.

The insurance company computer system may be configured to receive from a policyholder selection of premium billing to the primary policyholder or to the members for coverage associated with the members. For example, a policyholder may access the insurance company computer system to add an adult child as a member, and determine that the insurance company will direct premium billing for the coverage of the adult child to the policyholder. At a later time, determined at the discretion of the policy holder, such as when the adult child obtains a higher paying job, the policyholder may access the system and provide data indicative of instructions to have premium bills be directed to the adult child member for payment. The policyholder may have the option of furnishing data to the system indicative of instruction to be notified of late payments or underpayment by a member, prior to cancellation of the member's coverage and the system may be configured to permit the policyholder to make the payments prior to a deadline to avoid cancellation.

In an embodiment, the insurance company computer system may be configured to provide for, in data associated with a multi-generational policy, an available amount that can be paid in response to claims, providing coverage for a range of contingencies, including contingencies not typically covered by property and casualty policies. The available amount may be an overall cap on a coverage provided by the insurance company. The insurance company computer system may be configured to access stored algorithms for calculating the available amount based on the period of time the primary insured has had either a type of coverage, such as homeowners coverage, or any coverage, issued by the same company, as a loyalty benefit, for example. The algorithm may provide, for example, that an additional amount is added to the available amount if a policy has been maintained for a threshold period of time, such as a period of two years, five years or other time period. The available amount may be a fund that is started by a deposit from the primary insured, and is augmented by interest paid by the insurance company, by amounts awarded such as by loyalty benefits, and debited by deductions for certain contingencies.

In embodiments, the system may be configured to permit a member to be designated only based on a personal relationship or a family relationship between the primary insured and the member. The term “family relationship” may, in an embodiment, mean direct descendants and direct ancestors, and include only children, grandchildren, great-grandchildren, grandparents and great-grandparents. The term “family relationship” may mean, in addition to direct descendants and direct ancestors, one or more of: siblings and half-siblings; spouses, domestic partners and the like of direct descendants and direct ancestors; aunts, uncles, nieces, nephews, first cousins and the like. The definition of “family relationship” may include individuals who have been dependents or legal guardians of an individual at any time under applicable law, or for whom an individual has or previously had a power of attorney, by way of further example. For example, if an individual policy owner was a legal guardian of a niece or nephew for a period of time while the niece or nephew was a minor, then the niece or nephew, when an adult may be able to be a policy member on the individual's policy. The definition of “family relationship” may also exclude certain family relationships, such as family relationships by birth terminated by adoption, and family relationships established by adoption when the adoptee is an adult. The definition of family relationship employed is exclusive of persons not meeting the applicable definition of family relationship in an embodiment. A computer system may be configured to require a policyholder accessing the system from a remote device to designate a family relationship for a proposed new member based on a fillable form or a drop down menu, to compare a received designation of a family relationship to data indicative of a definition of a family relationship under the policy, and to provide an indication to the policyholder as to whether the proposed new member is eligible for coverage.

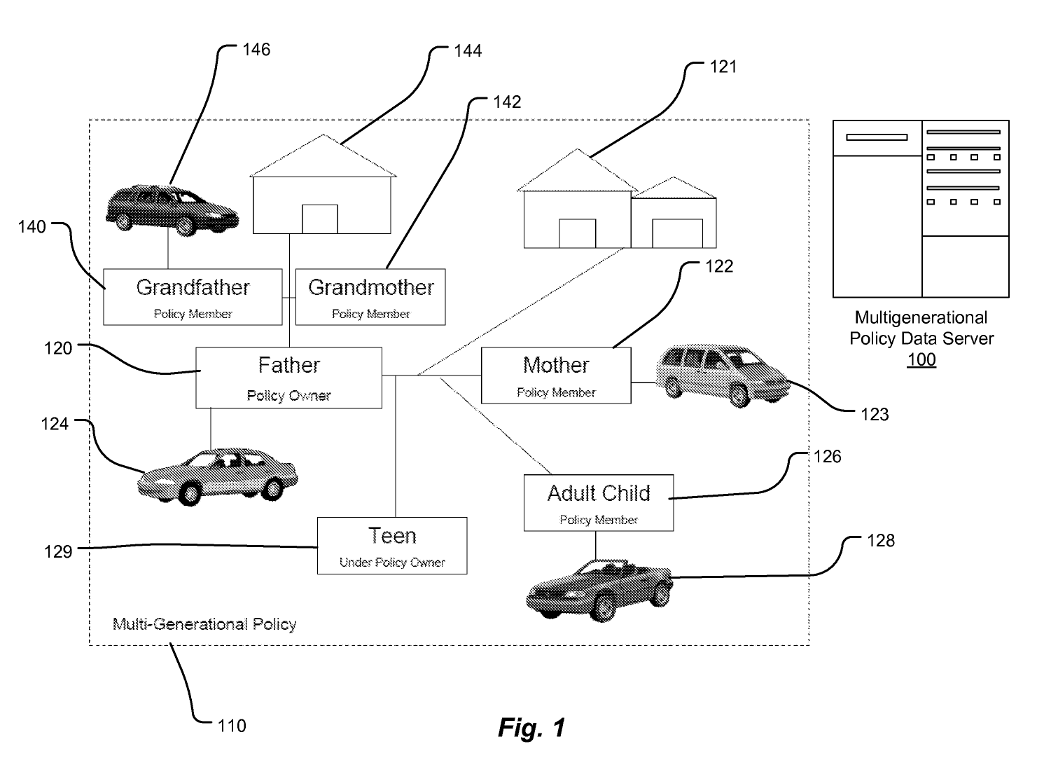

Referring to FIG. 1, an exemplary environment for an implementation of the invention is shown. Computer system 100 processes data relating to multigenerational insurance policies, and stores and processes data relating to family relationships and coverage of homes and vehicles indicated schematically by multi-generational policy 110. An insurance policy issuer and underwriting entity employs computer system 100 in connection with processing data related to illustrating, underwriting, issuing, administering, billing and claims processing for multi-generational insurance policies. Computer system 100 may interact with other insurance company computer systems In the exemplary family relationship shown in FIG. 1, father 120 is the policyholder or policy owner; the insurance company has issued the policy to father 120, and father 120 may interact with computer system 100 to add and remove members, determine coverage, and take other actions related to the policy. The terms “policy owner” and “policyholder” are used interchangeably to refer to the individual to whom the policy has been issued, and who has the right to add members. The spouse of the policy holder 120, mother 122 has been designated by policyholder father 120 as a policy member. policy holder 120 owns vehicle 124, and has a partial ownership interest, with mother 122, in home 121. A multigenerational policy covering vehicles covers father 120's interest in vehicle 124 and a multigenerational homeowners policy covers home 121. Mother 122 is the sole owner of vehicle 123 in this example. Multigenerational vehicle policy covers vehicle 123, with mother 122 being the insured and being a member. The teenage child 129 of father 120 and mother 122, whether living at home or away from home at a residential school or college, is covered as a driver under the policy owner's vehicle policy. The premium attributable to covering the teen 129 is included in the premium billed to and paid by father 120. Once the teen 129 has completed his or her education, the teen 129 will be eligible to be a policy member for coverage of a vehicle owned solely by the teen 129, or for homeowners or renters insurance at a separate residence of the teen 129.

Adult child 126 of father 120 is a policy member, selected by policy holder 120, with coverage under a multigenerational automobile insurance policy for vehicle 128 owned solely by adult child 126. The adult child 126 may be eligible for certain benefits under the policy by virtue of the fact that the father 120 is has those benefits available. For example, reduced deductibles based on length of time without an accident, or policy discounts, may be extended to adult child 126. The premium calculation for the adult child may be accomplished based on standard factors for an adult, with discounts applied at the end. For example, a premium may be determined based on tables based on the age of the adult child, the year, make and model of the child, location that the car is garaged, amount the vehicle is driven, and any history, such as tickets. The premium may then be discounted by a percentage based on a discount extended by virtue of the father 120 being entitled to the discount. Thus, the premium for an adult child with an age of 27 is typically higher than the premium for a parent with an age of 57, even if all other factors are the same, as the system will access tables indicating that premiums for a male in the age range of 26-30 are greater than premiums for a male in the age range from 41 to 60, by way of example. However, the premium for the adult child as determined by the system will be less than the premium had the adult child obtained coverage under a separate policy.

In an embodiment, the experience of the adult child is not employed by the system 100 in determining ratings and premiums for father 120 or other members. For example, if the adult child is convicted of one or more moving violations, is at fault in an accident, data accessible by the system associated with the adult child may include a rating of the adult child that triggers higher premiums. The rating of the adult child is not employed in algorithms used by the system to determine premiums of the father or other policy members.

In an embodiment, a rating of a member may be determined based on a combination of an overall rating for the family and an individual rating. The family rating may be determined based on an algorithm taking into account only the rating of the policy owner, for example.

In contrast, the rating of the teen 129 may be employed in algorithms for determining the premiums for the policy owner, as the teen 129 is covered as a resident minor family member.

The father 120 may interact with system 100 to provide for handling of premium billing. For example, premiums may be billed to father 120, who pays the insurance premiums, thereby assisting the adult child with funds.

Grandfather 140 and grandmother 142, the parents of father 120, are policy members, with coverage designated by policy holder 120. Grandfather 140 and grandmother 142 are owners of residence 144, and have been designated by policy holder 120 as policy members under the policy holder 120's homeowner's policy. System 100 processes data related to homeowners coverage as to residence 144, including determination of rating, premiums, administration of premium billing, and other data processing steps.

Grandfather 140 owns and is the sole driver of vehicle 146. Grandfather 140 has been designated a member under policy holder 120's automotive policy, and has coverage for vehicle 146 under policy holder 120's automotive policy.

Policy holder 120 may elect specific coverages and terms at a policy level, or may permit the members to make such elections individually. Thus, policy holder 120 may interact with system 100 via a user-accessible device to select the amount of deductibles, the level of uninsured motorist coverage above state-specified minima, and other policy options at a policy level. Alternatively, policy holder 120 may interact with system 100 so that system 100 requires input from the members to select specific coverages and terms in each policy.

It will be appreciated that the particular individuals and coverages illustrated in FIG. 1 are merely exemplary, and that the insurance policies and methods illustrated therein are not limited to the particular family relationships illustrated in FIG. 1, or to the homeowners and automobile coverage illustrated in FIG. 1.

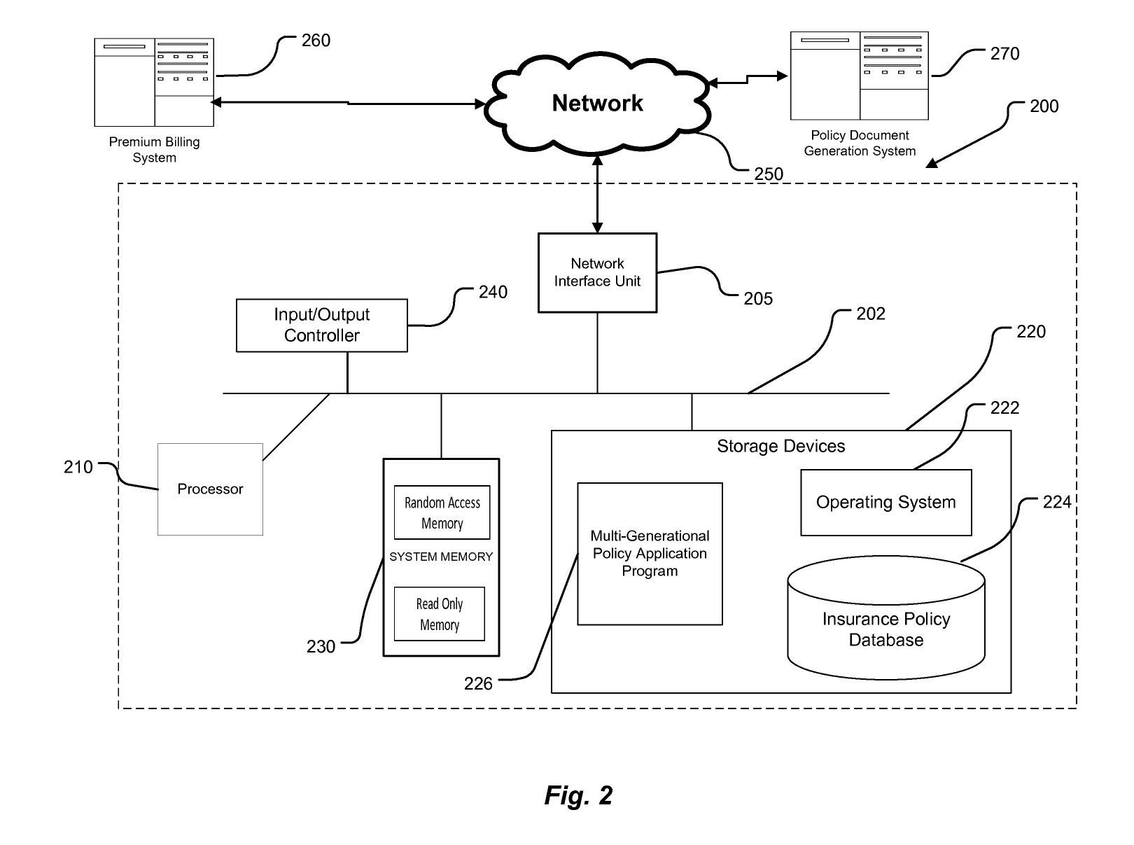

Referring to FIG. 2 an exemplary computer system 200 for use in an implementation of the invention will now be described. In computer system 200, processor 210 executes instructions contained in programs such as multi-generational policy application program 226, stored in storage devices 220. Other examples of application programs include application programs for processing applications, issuing policies, processing policy changes, including the addition and deletion of members by a policy holder, and generating premium bills and processing payments. Storage devices 220 may include suitable media, such as optical or magnetic disks, fixed disks with magnetic storage (hard drives), flash memory, tapes accessed by tape drives, and other storage media. Processor 210 communicates, such as through bus 202 and/or other data channels, with network interface unit 205, system memory 230, storage devices 220 and input/output controller 240. Via input/output controller 240, processor 210 may receive data from user inputs such as pointing devices (including mice and trackballs), touch screens, audio inputs and keyboards, and may provide data to outputs, such as data to video drivers for formatting on displays, data to print drivers for transmission for printing in hard copy or to image files, and data to audio devices. Storage devices 220 are configured to exchange data with processor 210, and may store programs containing processor-executable instructions, including instructions for implementing calculations employing algorithms, and values of variables for use by such programs. Processor 210 is configured to access data from storage devices 220, which may include connecting to storage devices 220 and obtaining data or reading data from the storage devices, or placing data into the storage devices 220. Storage devices 220 may include local and network accessible mass storage devices. Storage devices 220 may include media for storing operating system 222 and mass storage devices such as insurance policy data storage 224 for storing data related to policies and insureds. Such data may include data regarding policies, policy holders, members, relationships between policy holders and members, coverages, permissions granted by primary insureds to the members on policies, family ratings, individual rating factors, ratings of members, premiums, premium payments, rules for alerts relating to policies, such as alerts to notify a policy holder of a late premium payment by a member, a claim relating to a member, a requested change in coverage by a member, or other action taken by a member, and other relevant data. In an embodiment, inputs may include user interfaces, including workstations having keyboards, touch screens, pointing devices such as mice and trackballs, or other user input devices, connected via networked communications to processor 210. Network interface unit 205 may communicate via network 250 with other insurance computer systems, such as premium billing system 260 for generating premium bills and sending premium bills to members and policy holders, policy document generation system 270 for generating and printing policy documents for delivery to members and policy holders, and other exemplary systems not shown in FIG. 2, such as web servers, systems for issuing policies, systems for generation of illustrations for delivery to insureds, systems for intake of reports of claims from insureds, claims administration systems, systems of administration of collections of premiums due to an insurer, and systems of brokers, agents, financial advisors, policy holders and members, computer systems of banks and other financial institutions that effect payments of premiums under the policies and payments of claims under the policies, remote sources of data, and with systems for implementing instructions output by processor 210.

In other embodiments, one or more of the functions of other systems may be incorporated in the functionality of computer system 200. By way of example, computer system 200 may be configured both for administration of multi-generational insurance policies and for one or more of generating premium bills, generating policy documents, issuing policies, generation of illustrations, intake of claims from insureds, and other functions. Network 250 may be or include wired or wireless local area networks and wide area networks, and over communications between networks, including over the Internet. Any suitable data and communication protocols may be employed.

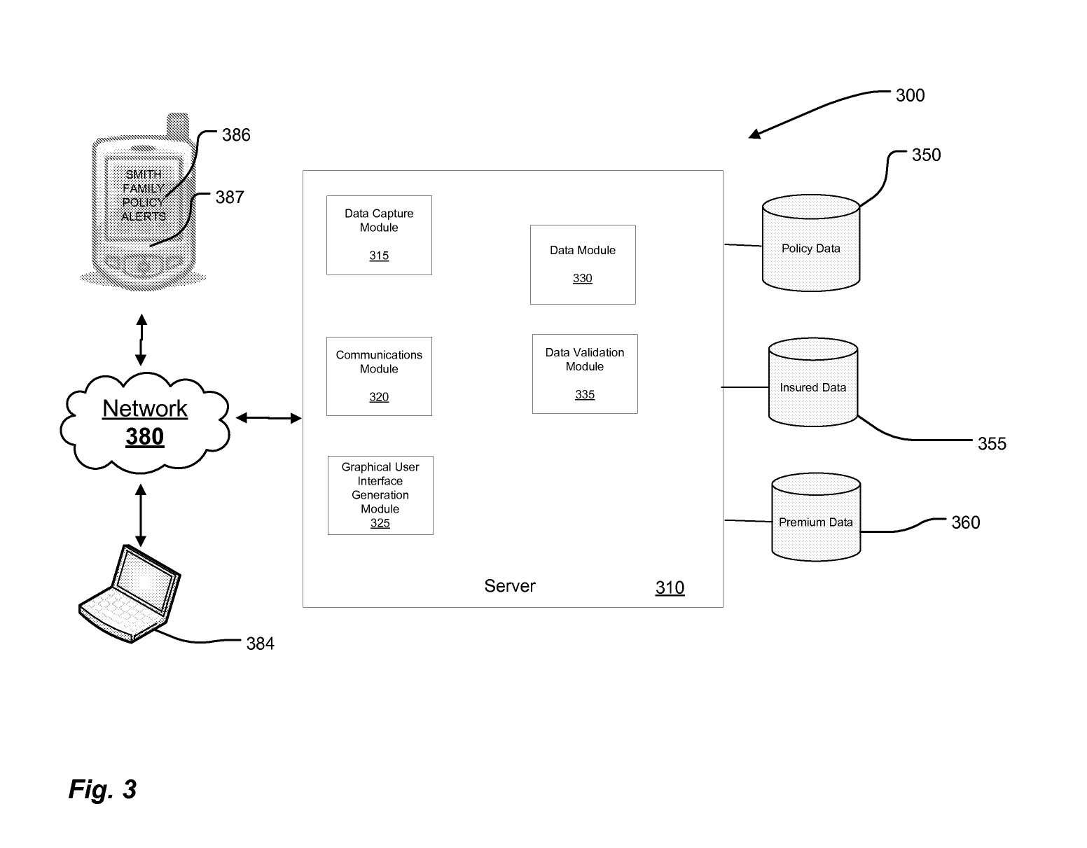

Referring now to FIG. 3, another exemplary embodiment of a system 300 of the present invention is shown. System 300 includes an insurance company server 310 which includes one or more engines or modules which may be utilized to perform one or more steps or functions of the present invention. In an embodiment, the present invention is implemented as one or more modules of a computer software program in combination with one or more components of hardware. Such software programs will be used generally where an agent, broker, financial advisor, policy holder, policy member, or other representative of an insured has sent a request for data or information to a server and comprises part of the processing done on the server side of the network. The program may be used in an Internet environment, where the server is a Web server and the request is formatted using HTTP (or HTTPS). Alternatively, the server may be in a corporate intranet, and extranet, or any other type of network. Use of the term “Internet” herein, when discussing processing associated with the user's request, includes these other network environments, unless otherwise stated. Additionally, a graphical user interface or insurance processing module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as smart phone 387 or laptop 384, and capable of being accessed and executed by a processor of the client device.

Referring still to FIG. 3, server 310 includes a data capture or input/output module 315, a communications module 320, a dynamic display generation or graphical user interface module 325, a data module 330, and a data validation module 335. Data module 330 is in further communication with a number of databases such as insurance policy database 350, insured database 355 and premium database 360. Databases in communication with server 310 may include both internal and/or external/third party databases. By way of example, external databases may include databases of financial services entities containing information relating to funds available for payment of premiums, data relating to requested new members of a policy for use in determining whether a requested new member meets applicable business rules for adding to a policy, verifying data related to policies, such as vehicle information, driving records, homeownership, residence addresses, age and other data. Server 310 may be configured for bulk upload of data for use in administration of policies, such as data relating to related individuals that a policy holder is requesting to have added as members on a policy, from a third party database or file, such as a spreadsheet file created by an agent or broker, or file or from another database or file of the insurance company. One or more modules may be configured to perform data validation steps prior to storing bulk uploaded data. Server 310 may further be configured to permit bulk download of data, such as policy, premium payment, and claim data, to a client device.

In operation, server 310 is in communication with client devices, such as computer 384 or smart phone 387 via a network which facilitates interaction with server 310 through one or more graphical user interfaces as shown and described herein. As used herein, devices, such as client devices 290, 294 may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 3, utilizing client devices 384, 387, a properly authenticated system user, such as a policy holder, a policy member, or a broker or agent, may view policy-related data, or initiate a policy-related transaction. A policy—related transaction may include a request to add a related individual as a new member, change the status of a covered child, such as a student living at home, to the status of a member when the child moves to a separate residence, select or change coverage for a policy member, select or change premium billing between a policy member and a policy holder, authorize a premium payment, change coverage for a policy for one insured or at a policy level, submit a claim or other type of policy-related transaction. A properly authenticated system user may review policy-related data, review the status of policy-related transaction, provide supplemental information (such as additional address or prior driving information for a member), in response to a request, using a user interface 386 on smart phone 387, for example. User interface 386 includes a display of a message provided to an authenticated user by server 310 to list alerts for a family insurance policy. The alerts may be provided in accordance with business rules which may be stored in policy database 350, for example. The business rules may be determined for all policies, may be parameters selected by the user, or may include default rules which may be modified by the user. For example, the alerts may include notification to a policy holder that the policy is due for renewal, that a claim has been submitted by one of the members, of developments related to a claim, such as a request for additional information, a decision to pay on the claim, or other development, that a premium payable by a member has not been paid in full when due, that a policy holder has earned or will soon earn a reduction in deductibles, an additional discount, or other favorable treatment, based on a time period of policy holding, number of members or other factors, or other alerts. By initiating a policy-related transaction, such as a change in coverage, the server may, responsive to receipt of data for the transaction, access data and perform calculations to determine a premium change, cause data indicative of a premium change to be displayed on the user-accessible device, and prompt the user for confirmation, and upon receipt of confirmation, provide data to an insurance computer system such as a policy document generation system for generation of policy documents reflecting the policy change for delivery to the policy holder, as well as provide data to another insurance computer system such as a premium billing system for generation of premium bills reflecting the change in coverage. Policy document generation may include formatting and sending instructions to a printer for printing of a paper copy of policy documents, or for generation of an electronic image of policy documents for transmission via e-mail or other protocol to a user or for upload on a web page or other accessible resource available to a user. A properly authenticated individual, such as an employee of an insurance company home office having administrative responsibilities, may access further data and provide updates and modifications to modules, updates of business rules, and other modifications. In the present invention, one or more of the above modules, may also be implemented in combinations of software and hardware for execution by various types of computer processors coupled to such hardware.

As used herein, a module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, define the module and achieve the stated purpose for the module such as implementing the business rules logic prescribed by the present system. In embodiments of the present invention a module of executable code may be a compilation of many instructions, and may be distributed over two or more different code partitions or segments, among different programs, and across two or more devices. Similarly, data, including by way of example policy data, insured data and premium data may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

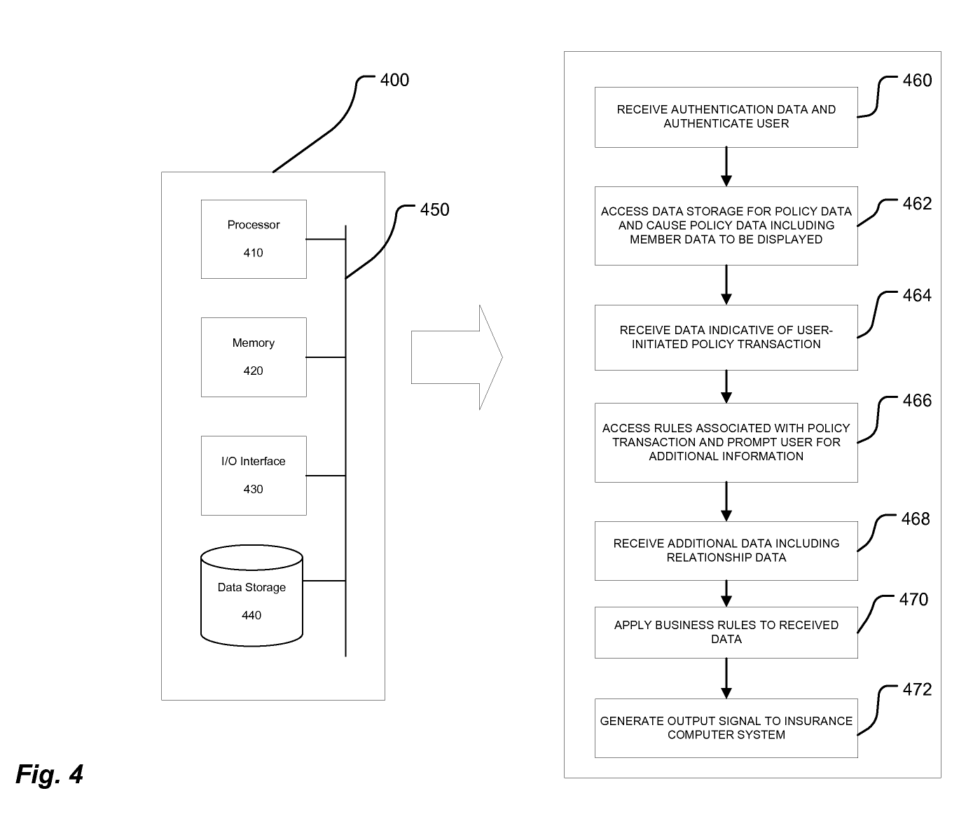

Referring to FIG. 4, in an embodiment, a computer server or client computer 400 running a client application such as a Web browser or a thick client application renders a graphical user interface, such as a series of screens to permit a user, such as a policy holder or a policy member, to view policy and insured information, including names and residence addresses of insureds, policy type, coverage, exclusions, policy documents, relationships of members to the policy holder, premium data including premium due dates, amounts of premiums due, and responsible insured, and other data. The graphical user interface may also include input screens to permit a user to provide input data to initiate policy transactions, such as adding or deleting members, changing an address of a member, initiating a premium payment, changing rules for providing alerts, and other data. Server or client computer 400 may include a processor 410, e.g. CPU, memory 420, I/O interface 430 and a storage mechanism 440 coupled together via a system bus 450 over which the various elements may interchange data and information. Computer 400 implements steps 460-472 in accordance with embodiments of the present invention.

Still referring to FIG. 4, computer 400 receives 460 authentication information from an authorized user, such as a policy holder, primary insured, an additional insured, an insurance agent or broker, and authenticates the user. Computer 400 may by default access 462 data from data storage 440 associated with the authorized user, such as multi-generational insurance policies in which the authorized user is a policy holder or member, and present an initial screen with policy-related data. The policy related data accessed and presented on the initial screen and subsequent screens, as well as the available functions, depends on the identity and role of the authorized user; rules may be stored in data storage 440 and accessed by processor 410 to determine the available data and functions. For example, for an authorized user such as a policy holder or an insurance company representative from a call center who is speaking with the policy holder, the policy-related data may include a listing of policies, a listing of insureds associated with each policy, and listings of data associated with each insured, such as relationship to the policy holder, residence address, and associated covered property, such as homes and vehicles. The initial screen may include links and tabs to permit the user to access additional information, such as additional information relating to a policy, an insured or a property or vehicle, or to functionality to permit initiation of a policy-related transaction. The initial screen may also include a listing of one or more messages or alerts in accordance with business rules, such as upcoming due dates for premium payment, renewals, providing additional information relative to claims, and for members to pay premiums. For an authorized user who is a member, the initial screen may include only data relating to the coverage for that member, and may not include coverage of the policy holder and other members.

The computer 400 may receive 464 data indicative of a user-initiated policy transaction, such as adding a member, with an indication of address, relationship and covered property (e.g., data relating to a vehicle of the added member), deleting an additional insured, or other transactions. Responsive to the request, the computer 400 may access business rules and prompt 466 the user to provide additional data. By way of example, in adding an additional insured, the user will be prompted to provide name, age, relationship to the primary insured, and, depending on the type of policy, data relating to the property or vehicle and coverage selections specific to the policy. The computer 400 may then receive the data, perform checks on the completeness of the data, and apply business rules 470 to proceed with further processing. In an embodiment, the computer provide an output signal 472 to other insurance computer systems, such as premium billing systems and policy document generation systems, dependent on the request and the business rules. The system may access available databases for data relative to a newly added member to determine whether the added member is eligible for insurance in accordance with policy rules. For example, the system may access data indicative of algorithms indicating that an individual meeting the definition of related relative to the policy holder is for insurance unless data associated with the individual is indicative of a very high level of risk, such as data indicative of insurance fraud associated with the individual, or one or more recent DWI convictions with respective to automotive insurance. The system may also access other sources of data, including government and private databases, periodical databases and social media, for data in order to made a determination as to insurability of an additional insured.

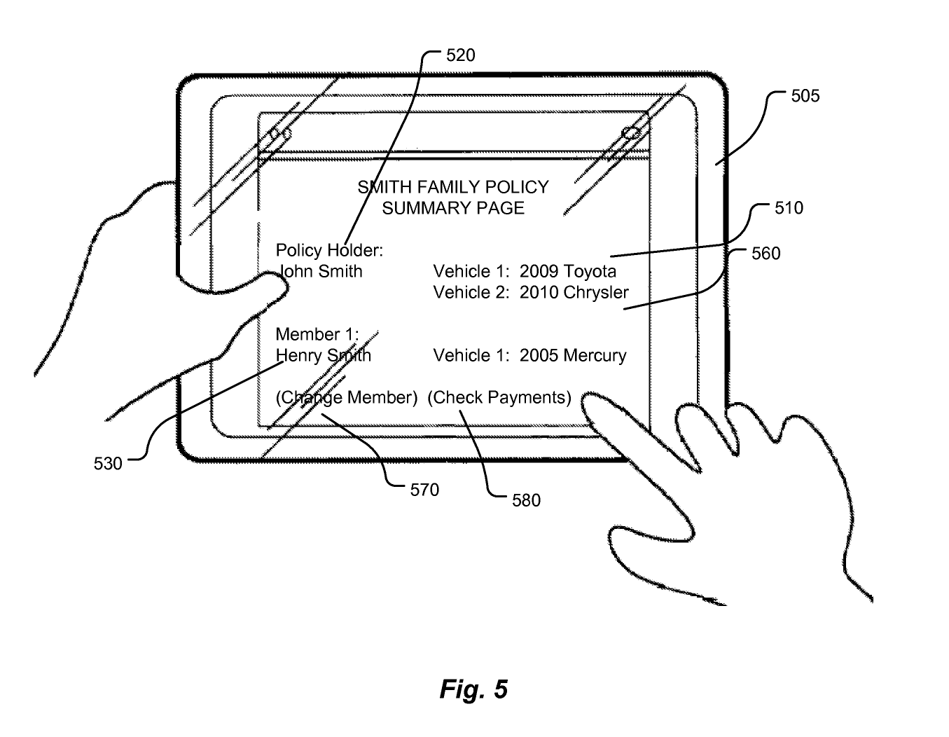

FIG. 5 is an exemplary screen shot of a screen on a client device in communication with a system for administration of insurance policy related data in accordance with an embodiment. The client device 505 is a tablet computer which is wireless communication with a computer system, such as system 400 of FIG. 4. The display 510 shows an initial screen presented to a policy holder under a policy in an embodiment. The initial screen identifies the policy as a family policy. The initial screen lists separately the policy holder 520 and each member 530. As this is an automotive policy, vehicles associated with each of the insureds are listed at 560. Each of the names of an insured may include a link that will cause the system to access and present additional data, such as residence address, relationship to the policy holder, age, and other data. The initial screen also includes options to select pages to initiate policy transactions as links, including an option to change members 570 and an option to check premium payments 580. The option to change members may include adding and deleting members, changing an address of a member, changing a status of a relative residing with the policy holder and driving a vehicle owned by the policy holder to a member having coverage for a vehicle owned by the member, and other changes. Options to check payments may include an option to see whether a member has made timely premium payments. Other options, such as options to change coverage, renew policies, and change vehicles, by way of example, may be available.

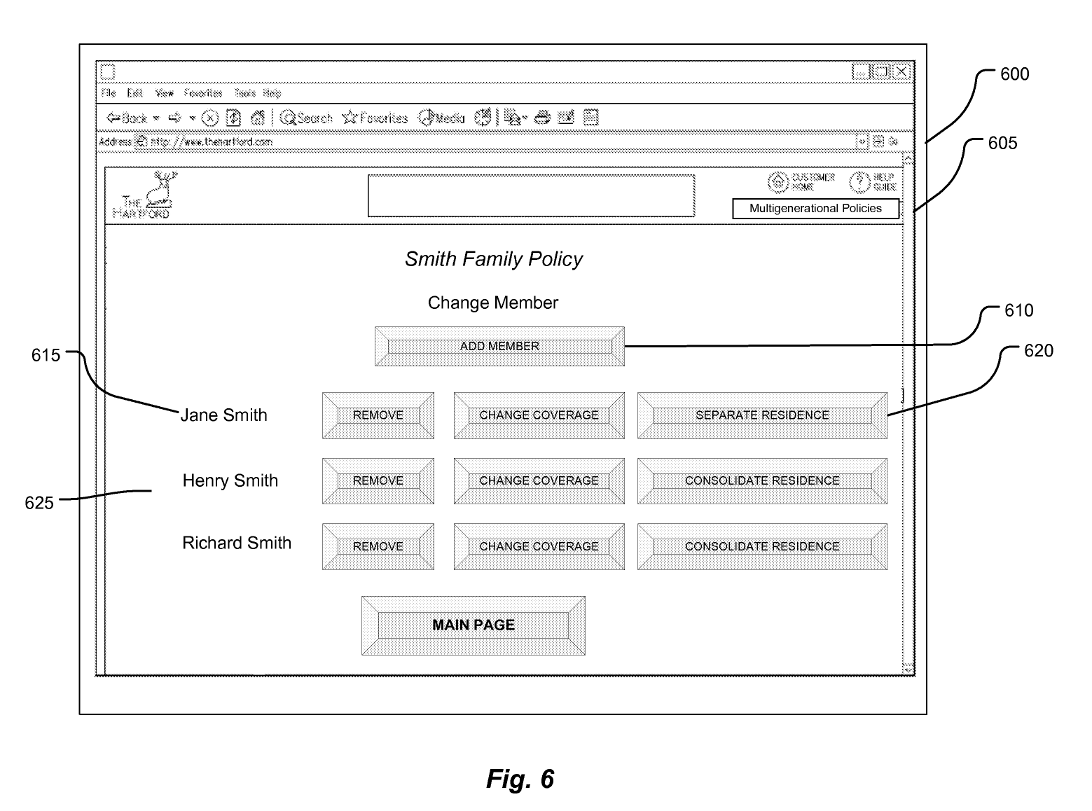

FIG. 6 is an exemplary screen shot of a screen on a client device for facilitating user change of members and selection of coverages for vehicles of related persons at multiple locations in an embodiment. The client device 600 has displayed thereon screen 605, which may be generated responsive to a change insured selection on an initial screen. Screen 605 presents an option to add member 610, which, when selected by the user, will cause the system to generate prompts for information needed for underwriting and adding a new member to a multi-generational policy. Screen 605 also presents current individuals associated with the policy. A child living at home 615 is listed first, with options including providing a separate residence 620 for the child. Children living with their parents are typically covered on their parents' automotive policies from the time they are teenagers. This policy option is an implementation which permits a child to transition to a member owning her own vehicle and having a different residence address.

Members covered under the policy are shown at 625. Options available include removing a member, changing coverage of a member, and consolidating the residence of a member with the residence of another insured. The consolidated residence may be the residence of the policy holder, or may be the residence of another member.

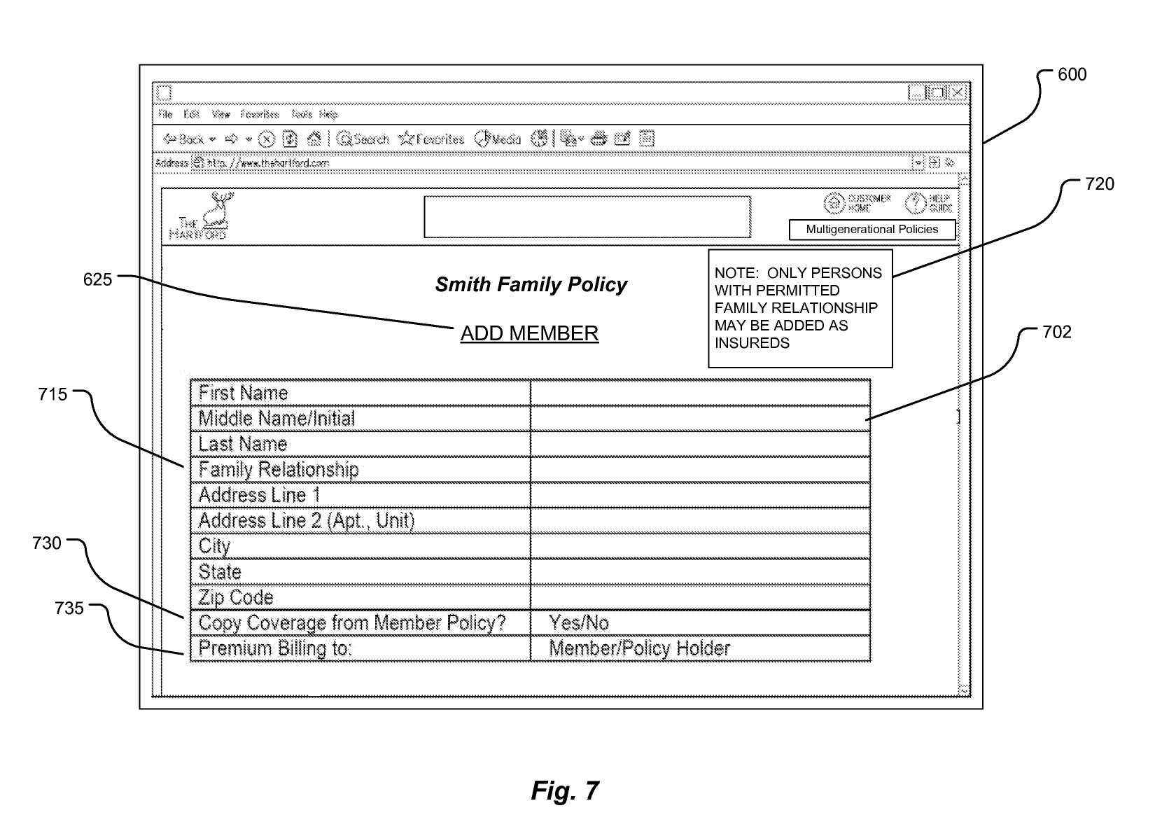

FIG. 7 is an exemplary screen shot of screen generated by the system in response to user selection of the “Add Member” option of FIG. 6. In this embodiment, the screen includes a table 702 prompting the user to enter in the fields in the right hand column information for the new member, including name and address, as well as family relationship 715. A pop up box 720 may provide a warning that only persons with a permitted family relationship may be added, responsive to user input of a relationship that is not permitted. For example, if the policy rules provide that only direct descendants and ancestors of the primary insured may be added as members, the pop up box 720 may be generated responsive to user input of the term “nephew.” In an embodiment, the family relationship item may include a drop down menu of permitted family relationships. The screen is also configured to prompt 730 the user to select whether or not to copy coverage from the policy holder. Responsive to user selection that coverage is not to be copied, the system may generate a listing of options, such as deductible amounts and other coverage options. The screen is also configured to prompt the user to select whether premium billing is to be directed to the member or to the policy holder at 735. The system may be configured to access stored data indicative of benefits accruing to the policy holder, and to associate those benefits with coverage for the member. Such benefits may include a decrease in deductibles resulting from the policy holder having maintained coverage for a period of time, or having avoided claims or accidents for a period of time, and the like.

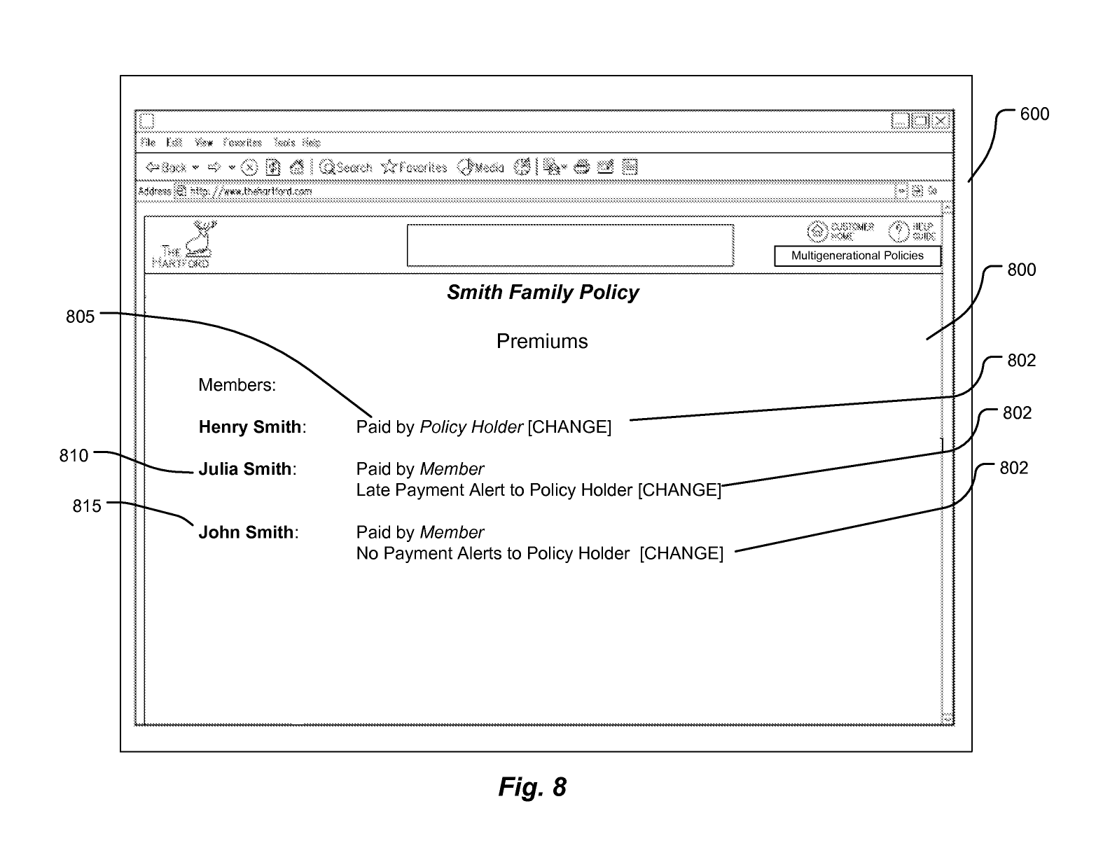

FIG. 8 is an exemplary screen shot of a screen 800 displayed on device 600, and displayed by the system responsive to a selection of a premium page. The system, responsive to a policy owner user selection of a premium page, accesses data including a listing of members associated with a policy, and data indicative of premium billing and alerts associated with the member, and populates screen 800 with the accessed data, thereby listing each member associated with the policy and associated premium billing and alert data for each member. A link 802 is provided associated with each member to provide instructions to the system to generate a screen providing the policy holder with options to select changed premium billing and alert values for members is provided. The current value for Henry Smith is value 805 that the premium is paid by the policy holder. The current value for Julia Smith is value 810 that the premium is paid by the member, but that there is a late payment alert provided to the policy holder. The late payment alert may be generated by the system with sufficient time for the policy holder to make the payment to prevent cancellation of the policy as to the member. In an embodiment, the system is configured to, responsive to receipt of data indicative of nonpayment of premium relating to a member, and expiration of any period for payment, provide data indicative of policy cancellation or cessation of coverage as to the member, but without cancellation of the policy as to the policy holder or any other member. The current value for member John Smith is value 815, that the premium is paid by the member and that no late payment alert is provided to the policy holder.

In embodiments, the system may be accessed by a policy owner or policy holder initiating a call to a call center. The call center personnel may have access to displays for a policy holder or a policy member, depending on the identity of the caller.

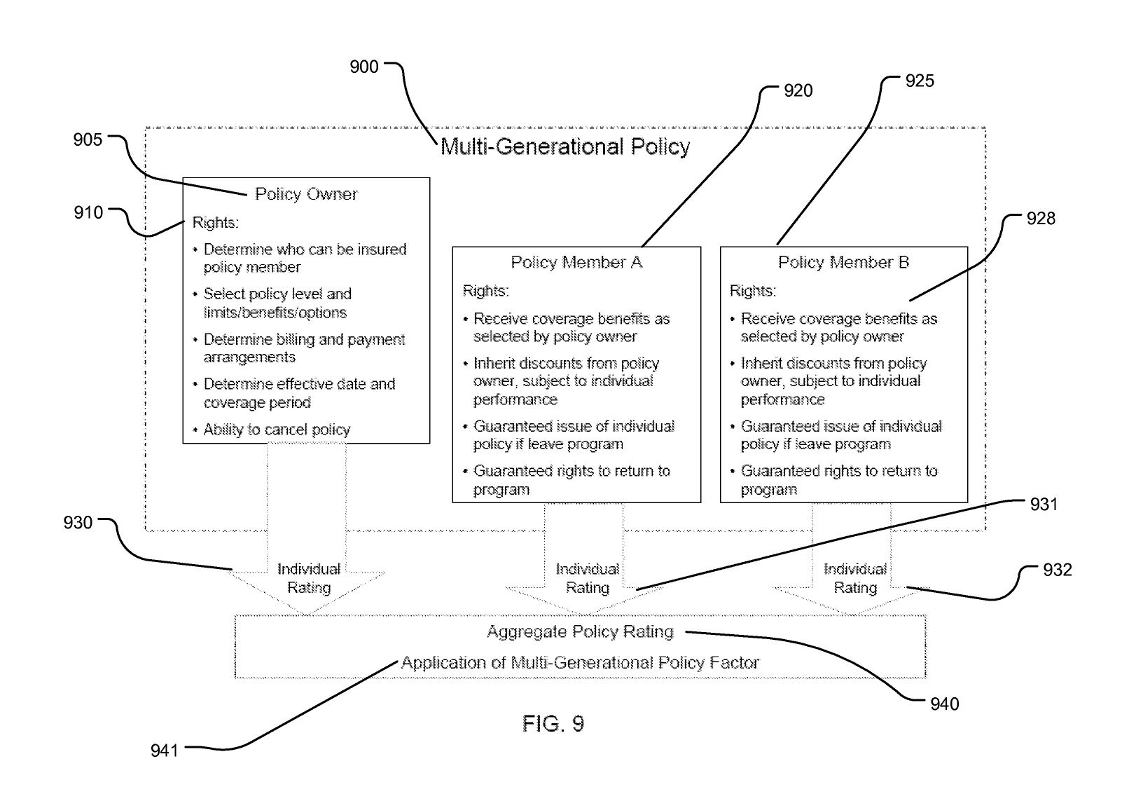

Referring to FIG. 9, a graphical representation of data stored in a data storage device associated with a multi-generational insurance policy administration computer system, showing relationships among the data, is provided. Policy 900 has associated therewith a policy holder 905. Policy holder 905 has certain rights 910, such that authorization from the policy holder 905 is required for the system to implement any of the actions listed at 910. In this example, the system is configured to require policy holder authorization for: a determination of whether a given individual may be a member; selection of type of policy, coverage levels, and benefits; determination of billing arrangements, e.g., whether premium bills are directed to the policy holder or to the member and whether payments are the responsibility of the policy holder or the member; selection of effective dates of the policy and of coverage for each member; and the right to cancel the policy as a whole.

The policy holder may have responsibility for payment of premiums, such that the system may be configured to provide that collections activity for nonpayment of premiums are to be directed to the policy holder. In an embodiment, the policy member and the policy holder may both be responsible for premiums for coverage of the policy member.

Data associated with policy members 920, 925 includes data indicative of rights of policy members under the policy. Data associated with the policy includes data indicative that Policy members are entitled to receive coverage associated with the policy, provided that the system has received data indicative of policy holder authorization, receive discounts and other benefits. Data associated with the policy may include algorithms which cause benefits not to be provided based on data associated with individual performance of a policy member. By way of example, a policy member may not be entitled to a reduced rate or increased deductible if the policy member has been issued one or more moving violations in a time window, such as within the last year, according to data stored or accessed by the system.

A policy member may have a right to guaranteed issue of a policy directly to the policy member, based on reduced underwriting. The rules employed by a system in determining whether a policy member is entitled to guaranteed issue may be the same as rules employed to determine if a relative is eligible to be a member, or may be different, more restrictive, or less restrictive. By way of example, a policy member may be entitled to issue of a policy directly so long as the system does not receive or access data indicative of high risks associated with the member. The system may have data associated with the policy issued directly to the member indicative of benefits or discounts transferring to the member automatically, such as for a period of years after issue of the direct policy.

A person having family relationship with the policy owner, whether a past policy member or not, may be guaranteed a right to become a policy member, based on a system being configured to approve a request to add the person as a policy member, absent the system accessing data indicative of unusually high risk. Data indicative of unusually high risk may include, for any policy, data indicative of insurance fraud committed by the proposed policy member, such as past applications or claims found to be highly inaccurate or fraudulent, data indicative of high risk behavior, such as convictions for certain crimes, or other data indicative of unusually high risk.

The data associated with policy members 920, 925, may differ, as different policy members may have different coverage and different histories.

The system is configured to generate individual ratings 930, 931, 932 for the policy owner and each of the policy members, based on individual factors of each policy owner and policy member, such as age, driving record, claims records, type of vehicle, location of vehicle, location of insured property, and other applicable data. A rating for an individual may be a value on a scale of ratings. The scale may be a one-dimensional rating scale from low risk to highest insurable risk.

The system is further configured, based on the individual ratings 930, 931, 932, and in some embodiments on other data, to determine an aggregate policy rating 940. In an embodiment, an aggregate policy rating may not employ ratings of policy members, but only ratings of policy owners. The aggregate policy rating 940 may be a rating on a one-dimensional scale from low risk to a highest insurable risk. The aggregate policy rating may be employed together with an individual rating to determine premiums for policy members and policy owners. A multi-generational policy factor 941 may also be employed. A system (such as system 100 of FIG. 1) may be configured to determine premiums based on algorithms including one or more of an individual rating, an aggregate policy rating, and a multi-generational policy factor.

In an embodiment, a system for processing data related to multi-generational insurance policies may employ data stored in distributed storage locations accessible via networks, including the Internet, including data stored in a “cloud,” and may process data at one or more remote processing locations in an application service provider implementation. In other embodiments, a system may include processing capability and data stored at a user-accessible device, such as a smart phone, tablet computer, notebook computer, desktop personal computer, netbook or other device, such that certain processing tasks, such as determination of whether a proposed new member is eligible, may be performed either on a processor of a user-accessible device, at a system processor, or may have tasks allocated between and among multiple processors at multiple locations.

In an embodiment, system alerts may be generated via any mode of communication, including e-mail, text message, message via a social media service, alert on a secure login page, personal or automated telephone notification, fax or postal mail.

In an embodiment, a policy benefit may be a fund that is available for any of the insureds to access subject to a claim setting forth a particular loss. The loss may be a property loss of any type that may be encountered, including vehicle or appliance mechanical issues, home repairs not caused by a typical covered loss, or other causes. The fund may be funded by payments made by the primary insured. The insurance company may credit interest on the payments, match payments, or fully fund the fund. Payments made by the insurance company responsive to claims may reduce the fund balance on a dollar for dollar basis, or on another basis.

A processor may provide the central processing unit (CPU) functions of a computing device on one or more integrated circuits. The term “processor” may include multi-core processors and central processing units including multiple microprocessors.

In embodiments, a processor may provide an output signal having data indicative of one or more data items. An output signal may be carried either over a suitable medium, such as wire or fiber, or wirelessly. An output signal may transmit data from one device to another directly, such as over a bus of a computer system from a processor to a memory device, or indirectly, such as over multiple networks, and with intermediate steps of storage in a buffer or memory device and retransmission. Such an output signal may be provided by the processor to a bus of a computer system together with address data at a series of clock intervals. The address data may designate a destination device on a bus, by way of example. In embodiments, an output signal may be a signal output from a hardware communications device of a computer system to a network, such as a local area network, a wide area network, or a network of interconnected networks, such as the Internet. Output signals may include, by way of example, data identifying formats, fields, and content of fields. Signals may be compatible with any appropriate format. For example, data may be formatted in accordance with a data format for insurance data, such as an ACORD compatible format. Reference to an output signal having particular data may include one or more signals bearing the information. Multiple signals bearing the information may include sequences of digital data bearing the information interleaved with sequences of digital data relating to other information. By way of example, a signal may be packetized for transmission. By way of further example, an output signal may take the form of an uncompressed digital signal or a compressed digital signal.

A system on which the methods of embodiments of the present invention may be implemented includes at least one central processing computer or computer network server. Network server includes at least one controller or central processing unit (CPU or processor), at least one communication port or hub, at least one random access memory (RAM), at least one read-only memory (ROM) and one or more databases or data storage devices. All of these later elements are in communication with the CPU to facilitate the operation of the network server. The network server may be configured in many different ways. For example, a network server may be a standalone server computer or alternatively, the functions of a network server may be distributed across multiple computing systems and architectures.

Network server may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP.

Data storage device may include a hard magnetic disk drive, optical storage units, CD-ROM drives, or flash memory. Data storage devices contain databases used in processing transactions and/or calculations in accordance with embodiments of the present invention, including at least a policy holder database and an insurance database. In one embodiment, database software creates and manages these databases. Insurance related calculations and/or algorithms in accordance with an embodiment of the present invention are stored in storage devices and executed by the CPU.

The controller comprises a processor, such as one or more conventional microprocessors and one or more supplementary co-processors such as math co-processors. The processor is in communication with a communication port through which the processor communicates with other devices such as other servers, user terminals or devices. The communication port may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices.

The processor also is in communication with a data storage device. The data storage device may comprise an appropriate combination of magnetic, optical and/or semiconductor memory, and may include, for example, RAM, ROM, flash drive, an optical disc such as a compact disc and/or a hard disk or drive. The processor and the data storage device each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wireline medium or combination of the foregoing.

The data storage device may store, for example, (i) a program (e.g., computer program code and/or a computer program product) adapted to or configured to direct the processor in accordance with embodiments of the present invention, and (ii) a database adapted to store information that may be utilized to store information required by the program. The program may be stored, for example, in a compressed, an uncompiled and/or an encrypted format, and may include computer program code. The instructions of the program may be read into a main memory of the processor from a non-transitory computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of embodiments of the present invention. Thus, embodiments of the present invention are not limited to any specific combination of hardware and software.

Suitable computer program code may be provided for performing numerous functions such as calculating ratings for policy owners, members and aggregate policy ratings; determining premiums; determining whether or not policy members are eligible for particular benefits, and the amount of those benefits. The functions described above are merely exemplary and should not be considered exhaustive of the type of function which may be performed by the computer program code of embodiments of the present inventions.

The computer program code required to implement the above functions (and the other functions described herein) can be developed by a person of ordinary skill in the art, and is not described in detail herein.

A computing system may include modules, which may be implemented in hardware, software, or combinations of software and hardware, operably inter-connected via a bi-directional connection with a central serial bus or other bus. A system may include a display module and a generating module. The generating module is used for generating insurance product contracts and other documents, which documents are then delivered to policy holders, policy members, agents and others, via any suitable hard copy or electronic method.

The computing system may be in communication with one or more payment systems for effecting payments of claims or refunds to policy owners, policy members, or designees, such as authorized vehicle repair shops.

The term “computer-readable medium” as used herein refers to any medium that provides or participates in providing instructions to the processor of the computing device (or any other processor of a device described herein) for execution. Such a medium may take many forms, including but not limited to, non-volatile media, non-transitory media, tangible media, volatile media, and transmission media. Non-volatile media and tangible media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers of embodiments of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

An exemplary advantage of a method and system of the present invention is that an individual can assist family members with management of insurance policies, even when the family members are adults that may reside at different locations, and even as to coverage of vehicles or property owned solely by the assisted family members. A method and system of the present invention provides flexibility for family members who may require or benefit from differing levels of assistance.

While particular embodiments of the invention have been illustrated and described in accordance with administration of insurance policies, various modifications and combinations can be made without departing from the spirit and scope of the invention, and all such modifications, combinations, and equivalents are intended to be covered and claimed.

1. A computer system for processing data related to a multigenerational insurance policy issued to a policy holder by an issuer, comprising:
a data storage device storing data associated with the policy, the data associated with the policy including data related to the policy holder; one or more coverages for the policy holder, one or more benefits associated with the policy, one or more coverages for one or more policy members, the one or more coverages for the one or more policy members comprising one or more coverages for at least one risk in which the policy holder does not have an insurable interest, a family relationship between the policy holder and each of the policy members, and an association of the one or more benefits with each of the policy members;
an interface device for communicating with a user accessible device and the data storage device; and
a processor in communication with the data storage device and the user accessible device, the processor configured to:
cause the user accessible device to display policy data, including policy holder data and policy member data;
receive via the user accessible device data indicative of a user-initiated policy transaction;
responsive to receipt of the data indicative of the user-initiated policy transaction, cause the user accessible device to display data indicative of the policy transaction, and
provide an output signal to a second computer system having data indicative of the user-initiated policy transaction.

2. The computer system of claim 1, wherein the user-initiated policy transaction comprises a request to add a proposed policy member, the data indicative of the user-initiated policy transaction comprising a name of the proposed policy member and a family relationship between the policy holder and the proposed policy member.

3. The computer system of claim 2, wherein the processor is further configured to access data indicative of a rating for the policy, an individual rating for the proposed member, and determine an overall rating for the proposed member based on the rating for the policy and the individual rating for the proposed member.

4. The computer system of claim 1, wherein the stored data comprises a rating for the policy and an individual rating for each of the policy members, and wherein the processor is configured to determine the rating for the policy independent of the individual ratings for each of the policy members.

5. The computer system of claim 1, wherein the one or more benefits comprise a reduced deductible determined based on a period of time of the policy holder not having been involved in an accident, the reduced deductible being associated with the one or more policy members.

6. The computer system of claim 1, wherein the one or more benefits comprise a premium credit based on number of renewals by the policy holder.

7. The computer system of claim 1, wherein the processor is further configured to prompt the policy holder responsive to nonpayment in full when due of a premium under the policy by the one or more members.

8. The computer system of claim 1, wherein the second computer system is a policy document generation system configured to generate policy documents responsive to the user-initiated policy transaction.

9. The computer system of claim 1, wherein the second computer system is a premium billing system configured to generate premium bills directed to the policy holder.

10. The computer system of claim 1, wherein the family relationship includes adult children, adult grandchildren, parents and grandparents.

11. The computer system of claim 1, wherein the user accessible device is configured for access by insurance company call center personnel.

12. The computer system of claim 1, wherein the processor is further configured for generation of premium bills.

13. The computer system of claim 1, wherein the processor is configured to permit a policy holder to initiate a request to add a member, and not to permit a member to initiate a request to add a member.

14. A computer-implemented method for processing data related to a multigenerational insurance policy issued to a policy holder and providing coverage to the policy holder and one or more policy members, comprising:
receiving at a processor of a computer system configured to process data related to multi-generational insurance policies, from a user-accessible device, data indicative of a request to initiate a policy transaction;
responsive to the request, accessing by the processor from a data storage device in communication with the processor data related to the policy, the data stored in the data storage device including data related to the policy holder, one or more coverages of the policy holder, the one or more policy members, one or more coverages of the one or more policy members, the one or more coverages of the one or more policy members comprising one or more coverages for at least one risk in which the policy holder does not have an insurable interest, and a family relationship between the policy holder and each of the members;
causing by the processor the user accessible device to display data responsive to the request for the policy transaction, and
providing by the processor an output signal to a second computer system having data indicative of the user-initiated policy transaction.

15. The computer-implemented method of claim 14, wherein the policy transaction is an addition to coverage of one of the members, and the processor accesses data indicative of one or more benefits associated with the policy, and stores data indicative of associating the one or more benefits with the addition to coverage.

16. The computer-implemented method of claim 14, wherein the displayed data is determined by the processor responsive to whether the request is received from the policy holder or one of the policy members.

17. The computer-implemented method of claim 16, wherein, responsive to a request from a policy holder, the processor causes the user accessible device to display data relating to all of the members.

18. The computer-implemented method of claim 14, wherein the policy transaction is a consolidation of address of one of the members with the policy holder.

19. The computer-implemented method of claim 14, wherein the transaction is a payment of a premium on coverage of a member by the policy holder.

20. The computer-implemented method of claim 14, further comprising providing an output signal for an alert to be communicated to the policy holder responsive to a user-selected parameter.

21. The computer-implemented method of claim 20, wherein the user-selected parameter comprises failure to pay in full when due a premium under the policy by one of the members.

22. The computer-implemented method of claim 14, wherein the second computer system is a premium billing computer system.

23. A non-transitory computer-readable medium, the computer-readable medium having processor-executable instructions stored thereon, which instructions, when executed by the processor, cause the processor to:
receive from a user-accessible device data indicative of a request to initiate a policy transaction related to a multi-generational insurance policy issued to a policy holder and having coverage for at least one policy member, selected by the policy holder and having a family relationship with the policy holder;
responsive to the request, access from a data storage device data related to the policy, the data stored in the data storage device including data related to the policy holder, coverages related to the policy holder; coverages of the at least one policy member, the coverages of the at least one policy member comprising coverages for risks in which the policy holder does not have an insurable interest; and a family relationship between the policy holder and the at least one policy member; and
provide an output signal for causing the user accessible device to display data responsive to the request for the policy transaction.

24. The computer-readable medium of claim 23, wherein the transaction is an addition of a policy member and is initiated by the policy holder, and the data responsive to the request comprises a prompt for a family relationship between the policy holder and a proposed added policy member.

25. The computer-readable medium of claim 24, wherein the instructions, when executed by the processor, further cause the processor to output a signal to a second computer system, the signal having data related to the policy transaction.

26. The computer-readable medium of claim 25, wherein the policy transaction is a change in coverage, and the signal has data indicative of the change in coverage for transmission to a policy document generation system for generation of corresponding policy documents.

27. The computer-readable medium of claim 23, wherein the policy is an automobile insurance policy.

28. The computer-readable medium of claim 27, wherein the policy transaction is an addition of a member for coverage relating to an automobile in which the policy holder does not have an ownership interest.

29. The computer-readable medium of claim 23, wherein the policy is a homeowners insurance policy.

30. The computer-readable medium of claim 23, wherein the policy transaction is an addition of a member for coverage relating to a property in which the policy holder does not have an ownership interest, and wherein the instructions further cause the processor to access data indicative of one or more benefits associated with the policy, and to store data indicative of associating the one or more benefits with the added member.
